(19) United States
(12) Patent Application Publication
(10) Pub. No.: US 2025/0269418 A1
(43) Pub. Date: Aug. 28, 2025

(54) MECHANICAL ARRANGEMENT AND METHOD FOR PROCESSING A SHEET-METAL STRIP UNWOUND FROM A COIL

(71) Applicant: TRUMPF WERKZEUGMASCHINEN SE + CO. KG, Ditzingen (DE)

(72) Inventors: Patrick Wowtscherk, Neschwitz (DE); Konrad Gnauck, Neukirch (DE); Markus Wowtscherk, Ralbitz-Rosenthal OT Schönau (DE)

(21) Appl. No.: 19/181,412

(22) Filed: Apr. 17, 2025

Related U.S. Application Data
(63) Continuation of application No. PCT/EP2023/078652, filed on Oct. 16, 2023.

(30) Foreign Application Priority Data
Oct. 18, 2022 (DE) 10 2022 127 171.4

(51) Int. Cl. B21D 43/02

(52) U.S. Cl. CPC B21D 43/021

(57) ABSTRACT

A mechanical arrangement for processing a sheet-metal strip unwound from a coil has a separating device disposed between the coil and a processing device in a feed direction (5). When a comparison device determines that a current strip length with which the sheet metal-strip has passed the separating point in the direction of the processing device coincides with a defined processing length of the sheet metal-strip over which the sheet-metal strip is to be processed by the processing device, the separating device is actuated and the sheet-metal strip is thereby separated at the separating point.

### CROSS REFERENCE TO RELATED APPLICATIONS

This application is a continuation of International Application No. PCT/EP2023/078652 (WO 2024/083731 A1), filed on Oct. 16, 2023, and claims benefit to German Patent Application No. DE 10 2022 127 171.4, filed on Oct. 18, 2022. The aforementioned applications are hereby incorporated by reference herein.

### FIELD

The invention relates to a mechanical arrangement for processing a sheet metal strip unwound from a coil,
having a feed device, by means of which the sheet metal strip unwound from the coil can be moved in a longitudinal direction of the sheet metal strip in a feed direction pointing away from the coil and which is arranged downstream of the coil in the feed device, and
having a processing device arranged downstream of the coil in the feed direction of the sheet metal strip unwound from the coil, to which processing device the sheet metal strip unwound from the coil can be fed by means of the feed device with a movement of the sheet metal strip n the feed direction and which is designed for processing the sheet metal strip unwound from the coil over a defined processing length of the sheet metal strip.

The invention also relates to a method for processing a sheet metal strip unwound from a coil using the above mechanical arrangement.

### BACKGROUND

Prior art of the type in question is known from DE 201 05 804 U1. This publication discloses a system for the separative processing of strip material which is unwound from a coil prior to processing. The strip material unwound from the coil is first moved by means of a conveyor station through a straightening station, which is arranged between the coil and the conveyor station. The conveyor then moves the straightened strip material to a processing station where the strip material is separated using a plasma or laser cutting device.

### SUMMARY

In an embodiment, the present disclosure provides a mechanical arrangement for processing a sheet metal strip unwound from a coil, the mechanical arrangement includes a feed device disposed downstream of the coil and configured to move the sheet metal strip unwound from the coil in a longitudinal direction of the sheet metal strip in a feed direction away from the coil. A processing device disposed downstream of the coil in the feed direction of the sheet metal strip unwound from the coil and configured to receive the sheet metal strip unwound from the coil via the feed device is configured to process the sheet metal strip unwound from the coil over a defined processing length of the sheet metal strip. A separating point can be formed by an actuable separating device disposed in the feed direction between the coil and the processing device on the side of the feed device facing the coil. The separating point capable of being passed in the direction of the processing device by the sheet metal strip unwound from the coil and moved in the feed direction via the feed device, wherein the sheet metal strip unwound from the coil is separable at the separating point by actuating the separating device. A measuring device is configured to continuously measure an instantaneous strip length of the sheet metal strip with which the sheet metal strip has passed the separating point of the separating device in the direction of the processing device at a respective measuring time. A comparison device is configured to continuously compare the instantaneous strip length of the sheet metal strip with the processing length of the sheet metal strip. The separating device for separating the sheet metal strip is actuatable so as to thereby separate the sheet metal strip at the separation point when the comparison device determines that the instantaneous strip length of the sheet metal strip corresponds to the processing length of the sheet metal strip.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a mechanical arrangement, and

FIG. 2 shows a numerical arrangement control.

### DETAILED DESCRIPTION

Based on the prior art, the object of the present invention is to avoid processing waste as far as possible when processing sheet metal from a coil.

According to the invention, this object is achieved by the arrangement and by the method according to the claims.

In the case of the invention, the processing device of the mechanical arrangement feeds exactly, or at least to very good approximation, the lengths of sheet metal strip that are to be processed in the case in question. The invention is particularly expedient in cases in which sheet metal strips with different properties are to be successively processed from the coil on a mechanical arrangement for sheet metal processing and in which the coil is not completely processed during a processing operation that precedes further processing. At the end of the first processing operation, the sheet metal strip unwound from the coil must be cut before the partially processed coil can be replaced by the coil for subsequent processing. Any residual length of the sheet metal strip already unwound from the coil in question after the first processing operation is generally unusable for the immediately subsequent processing operation. In the case of the invention, the unusable residual sheet metal strip length is minimized and processing waste is thus largely avoided.

As a processing device, the mechanical arrangement according to the invention can in particular have a separating device, preferably a laser separating device. A sheet metal strip drive of conventional design is conceivable as the feed device of the mechanical arrangement according to the invention, for example a feed station with drive rollers acting on the sheet metal strip to be moved and/or a workpiece support driven in the feed direction for the sheet metal strip on the processing device.

In an embodiment, it is advantageously avoided that the free end of the residual coil remaining after the sheet metal strip has been separated shows traces of mechanical stress. A sheet metal strip is mechanically stressed, for example, at a straightening station following the coil in the feed direction of the sheet metal strip.

In a preferred embodiment of the invention, the separating point of the separating device is positioned immediately downstream of the coil in the feed direction and thus very close to the coil. Due to the arrangement of the separating point according to the invention, only a short length of strip remains unwound from the remaining coil on the coil side after the processing length of the sheet metal strip has been separated. This free strip length is easy to handle and can therefore be rewound onto the remaining coil with little effort. In particular, arranging the separating point of the separating device near to the coil eliminates the need to withdraw the free end of the remaining coil from other functional units of the mechanical arrangement, for example from a straightening station, and to accept any associated mechanical stress on the free end of the remaining coil.

In a further development of the invention, a preferably mechanical fixing device, for example a mechanical fixing arm, is used to place an end of the coiled sheet metal strip projecting from the remaining coil after the processing length has been separated against the remaining coil.

Various types of devices can be used as separating devices for the arrangement according to the invention. In general, the separating point is defined by the separating tool of the separating device. For example, mechanical separating shears may be used as the separating device. The cutting edges of the mechanical separating shears form the separating point at which the processing length of the sheet metal strip unwound from the coil is separated.

In a further preferred embodiment of the invention, the separative processing of the sheet metal strip by the separating device near to the coil is carried out on the stationary sheet metal strip for the sake of simplicity.

According to the invention, in the case of a corresponding processing order, the processing length of the sheet metal strip unwound from the coil can be processed by the processing device in sections and accordingly in working cycles. Then, by means of the feed device, the processing length of the sheet metal strip is moved into the working region of the processing device section by section. In this case, the separating device of the mechanical arrangement according to the invention near to the coil is actuated to separate the processing length of the sheet metal strip as soon as it has been established by means of the comparison device of the mechanical arrangement that the processing length has been measured by means of the measuring device as the sum of the lengths of the strip sections with which the sheet metal strip has passed the separating point of the separating device in the feed direction in the direction of the processing device.

In the case of a further preferred design of the mechanical arrangement according to the invention, all essential functions of the mechanical arrangement are controlled by a numerical arrangement control.

The invention is explained in more detail below by means of an exemplary schematic representation of a mechanical arrangement according to the invention, which is designed for separating sheet metal from the coil.

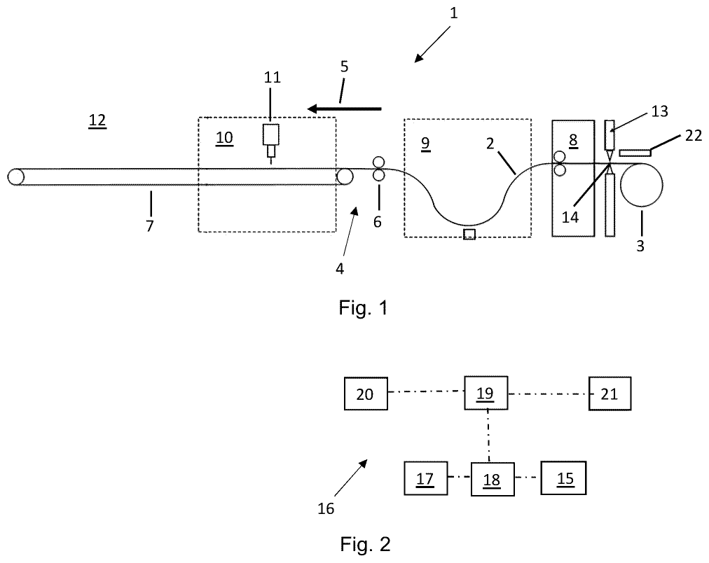

The mechanical arrangement 1 shown in FIG. 1 is used to process a sheet metal strip 2, which in its initial state is wound in the form of a coil 3 on a conventional reel. The sheet metal strip 2 is unwound from the coil 3 by means of a feed device 4 and moved in a feed direction 5. The feed device 4 comprises a pair of drive rollers 6, the drive rollers of which act on the sheet metal strip 2 on opposite sides, and an endlessly circulating sheet metal support strip 7, the upper run of which can be driven in the feed direction 5.

After being unwound from the coil 3, the sheet metal strip 2 reaches a functional unit of the mechanical arrangement 1 in the form of a straightening device 8. The sheet metal strip 2 is subjected to a straightening process in the straightening device 8.

The sheet metal strip 2, which is flat after the straightening process, passes through a strip store 9 as it continues to move in the feed direction 5 before it passes through the pair of drive rollers 6 of the feed device 4 and into a working region 10 of a processing device, which in the example shown is designed as a laser separating device 11.

After passing the pair of drive rollers 6 of the feed device 4, the sheet metal strip 2 is supported on the sheet metal support strip 7.

In the working region 10 of the mechanical arrangement 1, the sheet metal strip 2 is cut in a known manner. The feed device 4 is brought to a standstill while the sheet metal strip 2 is being processed by the laser separating device 11 and the laser separating device 11 is moved over the stationary sheet metal strip 2 with a biaxial working movement in a horizontal plane. The sheet metal strip 2 is cut to produce finished parts and a residual grid surrounding the finished parts.

Once processing in the working region 10 has been completed, the feed device 4 is switched on again and the finished parts and the residual grid move into an unloading region 12 following the working region 10 in the feed direction 5. There, the previously produced finished parts and the previously produced residual grid are unloaded from the sheet metal support strip 7 by means of an unloading device, not shown for the sake of simplicity.

In the example shown, the mechanical arrangement 1 is used to perform a processing task in which the sheet metal strip 2 is to be cut over a defined processing length that is greater than the range of the laser separating device 11 in the longitudinal direction of the strip in the working region 10 of the mechanical arrangement 1.

Due to these general conditions, the sheet metal strip 2 is fed to the working region 10 or the laser separating device 11 in cycles after being unwound from the coil 3, with strip sections the extension of which in the longitudinal direction of the strip is matched to the range of the laser separating device 11 in this direction.

To avoid processing waste, the laser separating device 11 feeds exactly the defined processing length of the sheet metal strip 2.

For this purpose, a separating device in the form of separating shears 13 is arranged in the feed direction 5 between the coil 3 and the feed device 4, which defines a separating point 14 by means of its cutting edges.

A measuring device 15 is provided at the separating point 14, which is integrated as a measuring unit in a numerical arrangement control 16. All essential functions of the mechanical arrangement 1 are controlled by means of the numerical arrangement control 16.

The processing length of the sheet metal strip 2 for the respective processing task is stored in a programmable memory 17 of the numerical arrangement control 16 shown in FIG. 2. The measuring device 15 is used to measure an instantaneous strip length of the sheet metal strip 2 with which the sheet metal strip 2 has passed the separating point 14 of the separating shears 13 in the direction of the processing device 4 at the respective measuring time. In the example shown, the instantaneous strip length of the sheet metal strip 2 is measured by the measuring device 15 as the instantaneous sum of the lengths of the strip sections that have passed the separating point 14 when the sheet metal strip 2 is pre-cycled in the feed direction 5.

A comparison unit 18 of the numerical arrangement control 16 provided as a comparison device is connected to the measuring device 15 and to the memory 17. The comparison unit 18 is used to continuously compare the current strip length of the sheet metal strip 2 measured by the measuring device 15 with the processing length of the sheet metal strip 2. If the comparison unit 18 establishes that the current strip length corresponds to the processing length of the sheet metal strip 2, a switching signal for a feed drive 20 of the feed device 4 and a switching signal for a separating drive 21 of the separating shears 13 are generated by means of a control unit 19 of the numerical arrangement control 16 provided as a switching device.

Due to the switching signal for the feed drive 20, the movement of the sheet metal strip 2 in the feed direction 5 is interrupted by bringing the drives for the drive roller pair 6 and for the sheet metal support strip 7 to a standstill. When the strip comes to a standstill, the separating shears 13 are actuated by the switching signal for the separating drive 21 and the metal strip 2 is separated at the separating point 14 of the separating shears 13.

As a result of the separating of the sheet metal strip 2 at the separating shears 13, a free sheet metal strip end is formed on the side of the separating point 14 facing the coil 3, which protrudes from the remaining coil 3. This free sheet metal strip end is placed against the remaining coil 3 by means of a fixing device in the form of a conventional contact arm 22. The coil 3 can then be replaced by another coil for a subsequent processing step if necessary.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A mechanical arrangement for processing a sheet metal strip unwound from a coil, the mechanical arrangement comprising:
a feed device disposed downstream of the coil and configured to move the sheet metal strip unwound from the coil in a longitudinal direction of the sheet metal strip in a feed direction away from the coil;
a processing device disposed downstream of the coil in the feed direction of the sheet metal strip unwound from the coil and configured to receive the sheet metal strip unwound from the coil via the feed device and configured to process the sheet metal strip unwound from the coil over a defined processing length of the sheet metal strip;
a separating point formed by an actuable separating device disposed in the feed direction between the coil and the processing device on the side of the feed device facing the coil, the separating point capable of being passed in the direction of the processing device by the sheet metal strip unwound from the coil and moved in the feed direction via the feed device, wherein the sheet metal strip unwound from the coil is separable at the separating point by actuating the separating device;
a measuring device configured to continuously measure an instantaneous strip length of the sheet metal strip with which the sheet metal strip has passed the separating point of the separating device in the direction of the processing device at a respective measuring time; and
a comparison device configured to continuously compare the instantaneous strip length of the sheet metal strip with the processing length of the sheet metal strip,
wherein the separating device for separating the sheet metal strip is actuatable so as to thereby separate the sheet metal strip at the separation point when the comparison device determines that the instantaneous strip length of the sheet metal strip corresponds to the processing length of the sheet metal strip.

2. The mechanical arrangement according to claim 1, further comprising a functional unit disposed in the feed direction between the coil and the processing device, configured to mechanically stress the sheet metal strip moving in the feed direction, and wherein the separating point is disposed in the feed direction between the coil and the functional unit.

3. The mechanical arrangement according to claim 1, wherein the separating point of the separating device is arranged immediately downstream of the coil in the feed direction.

4. The mechanical arrangement according to claim 1, wherein a fixing device is provided, by means of which, after the sheet metal strip has been separated, an end of the sheet metal strip projecting from a remaining coil can be placed against the remaining coil on the coil side.

5. The mechanical arrangement according to claim 1, wherein separating shears are provided as the separating device.

6. The mechanical arrangement according to claim 1, wherein the feed device is switchable by actuating a switching device, and wherein the feed device can be brought to a standstill by actuating the switching device when the comparison device determines that the instantaneous strip length of the sheet metal strip corresponds to the processing length of the sheet metal strip and before the separating device for separating the sheet metal strip is actuated.

7. The mechanical arrangement according to claim 1, wherein the processing length of the sheet metal strip can be fed to the processing device in sections in the form of strip sections via the feed device, and wherein the measuring device is configured to continuously measure the instantaneous strip length of the sheet metal strip as an instantaneous sum of the lengths of the strip sections with which the sheet metal strip has passed the separating point of the separating device in the feed direction in the direction of the processing device at the respective measuring time.

8. The mechanical arrangement according to claim 1, further comprising a programmable numerical arrangement control configured to store the processing length of the sheet metal strip wherein the programmable numerical arrangement control includes the measuring device and the comparison unit and further includes:
a measuring device configured to continuously measure an instantaneous strip length of the metal strip can be continuously measured at the respective measuring time,
a control unit connected to the comparison unit configured to actuate the separating device.

9. A method for processing a sheet metal strip unwound from a coil, the method comprising:
moving the sheet metal strip unwound from the coil in a longitudinal direction of the sheet metal strip using a feed device in a feed direction away from the coil, wherein the feed device is disposed downstream of the coil in the feed direction, and
feeding the sheet metal strip unwound from the coil using the feed device to a processing device disposed downstream of the coil in the feed direction of the sheet metal strip unwound from the coil, wherein the processing device is configured to process the sheet metal strip unwound from the coil over a defined processing length of the sheet metal strip,
forming a separating point using an actuable separating device disposed in the feed direction between the coil and the processing device on the side of the feed device facing the coil, passing the separating point in the direction of the processing device by the sheet metal strip,
continuously measuring, using a measuring device, an instantaneous strip length of the sheet metal strip with which the sheet metal strip has passed the separating point of the separating device in the direction of the processing device at the respective measuring time,
continuously comparing the instantaneous strip length of the sheet metal strip with the processing length of the sheet metal strip using a comparison device, and
actuating the separating device for separating the sheet metal strip so as to thereby separate the sheet metal strip at the separation point when the comparison device determines that the instantaneous strip length of the sheet metal strip corresponds to the processing length of the sheet metal strip.
